(19) United States
(12) Patent Application Publication
(10) Pub. No.: US 2004/0116072 A1
(43) Pub. Date: Jun. 17, 2004

(54) Data transfer

(76) Inventor: Natividade Albert Lobo, Windsor (GB)

Correspondence Address: HARRINGTON & SMITH, LLP, 4 RESEARCH DRIVE, SHELTON, CT, 06484-6212, US

(21) Appl. No.: 10/470,666

(22) PCT Filed: Feb. 4, 2002
(86) PCT No.: PCT/GB02/00476

(30) Foreign Application Priority Data
Feb. 5, 2001 (GB) 0102813.3

(51) Int. Cl. H04B 5/00; H04B 1/38

(52) U.S. Cl. 455/41.2; 455/550.1

(57) ABSTRACT

The present invention relates to a transmitting low power radio frequency transceiver capable of participating in a radio network including one or more other low power radio frequency transceivers, comprising storage means arranged to store data indicative of both the address and clock time of each of one or more other lower power radio frequency transceivers, and a transmitter for transmitting the stored data indicative of both the address and clock time of one or more other low power radio frequency transceivers. It also relates to a receiving low power radio frequency transceiver, comprising means for receiving from a first low power radio frequency transceiver a message comprising data indicative of the address and clock time of at least a second low power radio frequency transceiver, different from the first low power radio frequency transceiver, and means for using said data indicative of the address and clock time to page a low power radio frequency transceiver.

The present invention relates to the communication of information between low power radio frequency transceivers. In particular, it relates to the effective communication of information to a low power radio frequency transceiver to allow it to form an ad-hoc network with one or more local low power radio transceivers.

A Bluetooth network is formed by a transceiver which acts as a master and pages the transceivers within range to form the network or join them to the network. Before the master can page another transceiver it has to know it is within its range and have certain information relevant to that transceiver which allows it to page that transceiver. In Bluetooth, the relevant information for each transceiver within range may be obtained by an Inquiry Procedure. However, the inquiry procedure may take as long as 10.24 s for a transceiver to complete during which time the radio spectrum is occupied.

It would be desirable to improve the use of the radio spectrum.

According to one aspect of the present invention there is provided a low power radio frequency transceiver as claimed in claim 1.

According to another aspect of the present invention there is provided a low power radio frequency transceiver as claimed in claim 6.

According to a further aspect of the present invention there is provided a method as claimed in claim 12.

Embodiments of the present invention relate to the adaptation of the existing low power radio frequency transceivers. As the existing low power radio frequency transceivers are primarily software controlled, they may be adapted by updating the controlling software using a computer program stored on a computer program product. The computer program product may be a storage medium, for example a floppy disc, a CD-ROM, a DVD, a semi-conductor memory, that permanently or transiently stores data. Consequently, according to a still further aspect of the present invention there is provided a computer program product as claimed in claim 14 and a computer program product as claimed in claim 15.

For a better understanding of the present invention and to understand how the same may be brought into effect reference is made by way of example only to the following figures:

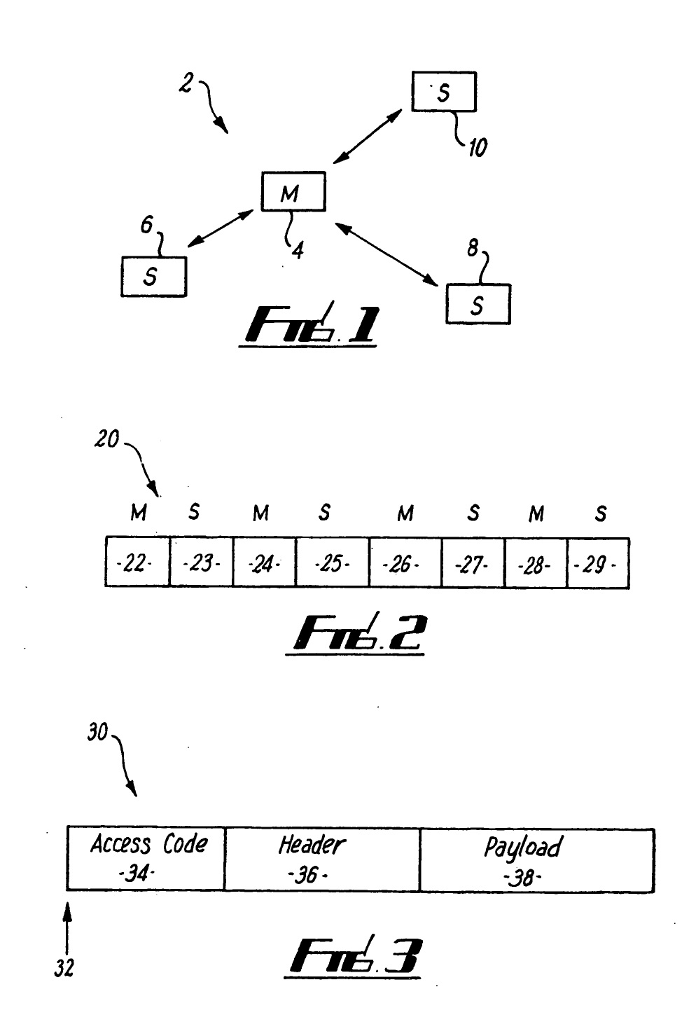

FIG. 1 illustrates a radio network;

FIG. 2 illustrates the timing of packet transmission and reception in the network;

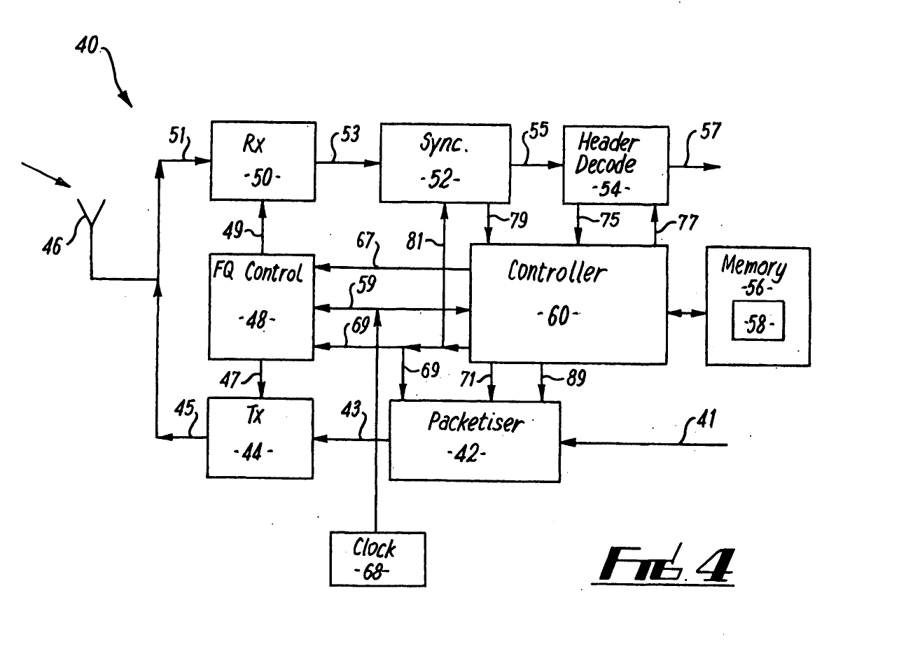

FIG. 3 illustrates a packet transmitted in the network;

FIG. 4 illustrates a transceiver unit in more detail; and

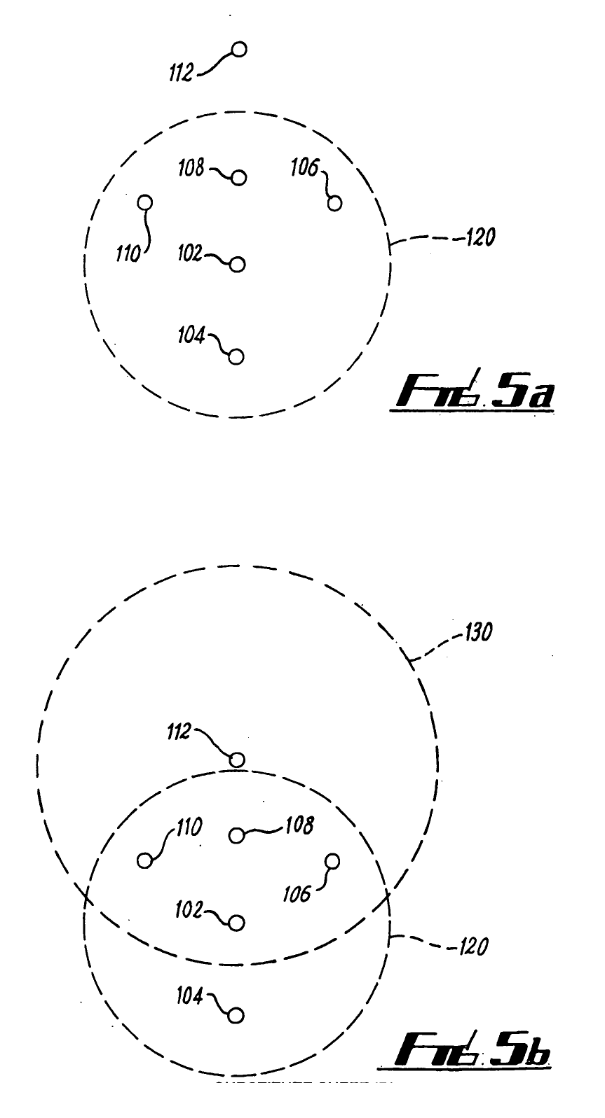

FIGS. 5a and 5b illustrate an arrangement of transceivers.

FIG. 1 illustrates a network (Bluetooth piconet) 2 of radio transceiver units, including a master unit 4 and slave units 6, 8 and 10, communicating by transmitting and receiving radio packets. The master unit is the transceiver unit which initiates the connection of a slave to the network. There is only one master in a network. The network operates in a time division duplex fashion.

The transceivers transmit and receive, in this example, in a microwave frequency band, illustratively 2.4 GHz. The network reduces interference by changing the frequency at which each radio packet is transmitted. A number of separate frequency channels are assigned each with a bandwidth of 1 MHz, and the frequency may hop at a rate of 1600 hops/s.

Referring to FIG. 2, a frame 20 is illustrated. This frame 20 is the time frame used by the master unit 4. The frame illustratively has slots 22 to 29 of equal length. The slots designated by even numbers are reserved. Only the master unit can begin transmitting a radio packet aligned with the start of the even numbered slots. The slots designated by odd numbers are reserved. Only radio packets transmitted by a slave, that is, radio packets addressed for reception by the master unit can have their start aligned with the start of the odd numbered slots. Each slot is allocated a different one of a sequence of hopping frequencies. A slot has a constant time period and is typically 625 microseconds.

The network is a radio frequency network suitable for transmitting voice information or data information between transceivers. The transmissions made are of low power, for example 0 to 20 dBm, and the transceiver units can effectively communicate over the range of a few centimetres to a few tens or hundred of metres. The master unit has the burden of identifying the other transceiver units within its transmission range which is achieved using an Inquiry Procedure, and the burden of paging a transceiver unit to set up a communication link between the master unit and that slave unit which is achieved using an Access Procedure.

Referring to FIG. 3, a typical radio packet 30 is illustrated. The radio packet has a start 32 and contains three distinct portions: a first preamble portion contains an Access Code 34, a second portion contains a Header 36 and a third portion contains a Payload 38.

The Access Code is a series of bits used in the network to identify the start of a radio packet and effect synchronisation and DC estimation. There are three types of Access Codes. The Channel Access Code is included in all packets communicated in the piconet channel. The Device Access Code is used during the Access Procedure. The Inquiry Access Code is used during the Inquiry Procedure to discover which Bluetooth units are within range.

The inquiry procedure enables a unit to discover which units are within range, and what their device addresses (BD_ADDR) and clock values are. The discovering unit transmits an inquiry message (ID packet) at different hop frequencies. A unit within range of the inquiring master will respond to the inquiry message by sending an FHS packet which contains the slave's Bluetooth Device Address (BD_ADDR), the value of the slave's native system clock and other slave information such the Class of device and, as yet, undefined fields.

The broadcast inquiry message will elicit a response from all units within range if the general Inquiry Access Code (GIAC) is used as the Inquiry message access code. However, it is also possible to direct the Inquiry procedure to a particular class of devices e.g. printers or facsimile machines by using the relevant dedicated inquiry access code (DIAC) in place of the GIAC.

The Access Procedure is a paging procedure which sets up a connection to a paged transceiver. The unit carrying out this procedure becomes the master of the piconet. The master repeatedly transmits the slave's device access code in different hop channels. An ID packet is transmitted which has no header or payload and has the destination unit's access code (DAC) as its Access Code. The DAC is derived from the unit's Bluetooth Device Address (BD_ADDR). A train of identical ID packets (two per slot) are transmitted each at different hop frequencies (see FIGS. 10.6 & 10.7 of the Bluetooth Baseband Specification v1.0B, 29th Nov. 1999). The master listens for a response after each transmission slot. The frequency hopping sequence is determined from the slave's Bluetooth Address (BD_ADDR). The master uses the value of the slave's clock received during an Inquiry Procedure to estimate the correct phase of the sequence.

In the Connection State, the connection between the master unit and slave unit has been established and packets can be sent back and forth. The packets use as the Access Code, the same channel access code (derived from Bluetooth device address BD_ADDR of the master unit supplied during the Access Procedure) and the same frequency hopping sequence, the channel hopping sequence (derived from Bluetooth device address BD_ADDR of the master unit supplied during Access Procedure).

Referring to FIG. 4, a schematic illustration of a transceiver unit is shown. Only as many functional blocks and interconnections are shown in this diagram as are necessary to explain in the following how a transceiver unit and the communication network operates. The transceiver unit 40 contains a number of functional elements including: an antenna 46, receiver 50, synchroniser 52, header decoder 54, controller 60, memory 56 having memory portion 58 storing the transceiver unit's BD_ADDR, packetiser 42, clock 68, frequency hop controller 48 and transmitter 44. Although these elements are shown as separate elements they may in fact be integrated together and may be carried out in software or in hardware.

Data to be transmitted in the payload of a packet by the transceiver unit 40 is supplied as data signal 41 to the packetiser 42. Control information to be transmitted in the payload of a packet is supplied in a payload control signal 89 provided by the controller 60 to the packetiser 42. The packetiser 42 also receives an access code control signal 69 and a header control signal 71 from controller 60 which respectively control the Access Code 34 and the Header 36 attached to the payload to form the packet 30. The packetiser 42 places the data or control information into a packet 30 which is supplied as signal 43 to the transmitter 44. The transmitter 44 modulates a carrier wave in dependence upon the signal 43 to produce the transmitted signal 45 supplied to the antenna 46 for transmission. The frequency of the carrier wave is controlled to be one of a sequence of hop frequencies by a transmission frequency control signal 47 supplied by the frequency hop controller 48 to the transmitter 44.

The antenna 46 receives a radio signal 51 and supplies it to the receiver 50 which demodulates the radio signal S1 under the control of a reception frequency control signal 49 supplied by the frequency hopping controller 48 to produce a digital signal 53. The digital signal 53 is supplied to the synchroniser 52 which synchronises the transceiver unit 40 to the time frame of the network. The synchroniser is supplied with an access code signal 81 specifying the Access Code of the packet which the transceiver unit is expecting to receive. The synchroniser accepts those received radio packets with Access Codes which correspond to the expected Access Codes and rejects those received radio packets with Access Codes that do not correspond to the expected Access Code. A sliding correlation is used to identify the presence and the start of the expected Access Code in a radio packet. If the radio packet is accepted then the radio packet is supplied to the header decoder 54 as signal 55 and a trigger signal 79 is returned to the controller 60 indicating that the packet has been accepted by the synchroniser 52. The trigger signal 79 is used by the controller, in a slave unit, to synchronise to the master clock. The controller compares the time at which a radio packet was received with the time at which the radio packet was expected to be received and shifts its timing to offset the difference. Such an offset may be achieved by varying the value of an offset stored in memory 56 by the value of the difference. The header decoder 54 decodes the header in the received packet and supplies it to the controller 60 as header signal 75. The header decoder 54, when enabled by a payload acceptance signal 77 supplied by the controller 60, produces a data output signal 57 containing the remainder of the radio packet, the payload 38. The frequency-hopping controller 48 cycles through a sequence of frequencies. The transmission frequency control signal 47 and the reception frequency control signal 49 normally alternately control the transmitter 44 and the receiver 50.

The memory 56 has a portion 58 which permanently stores the BD_ADDR of the transceiver unit 40. The remaining portion of the memory 56 can be written to by the controller 60.

The native clock 68 may be realised as a 28-bit counter that wraps around at 2²⁸-1. The least significant bit ticks at units of 312.5 microseconds, giving a clock rate of 3.2 kHz. The native clock 68 is not adjusted or turned off and has no relation to the time of day. Offsets are used to provide from units'native clocks, mutually synchronised Bluetooth clocks.

FIG. 5a illustrates an arrangement 100 of transceivers 102, 104, 106, 108, 110, 112. The dotted circle 120 illustrates the range of transmission of the transceiver 102. The transceivers 104, 106, 108 and 110 lie within the circle and can be reached by messages transmitted by the transceiver 102. The transceiver 112 is outside the circle 120 and cannot be reached by messages transmitted by the transceiver 102.

According to the prior art, the transceiver 102 would have identified the transceivers which are within range 120 by performing an Inquiry procedure. Each of the transceivers 104, 106, 108 and 110 would have separately responded with an FHS message identifying its own Blue tooth Device Address and its own native clock value. The transceiver 102 could then have used the received messages to initiate a Paging Procedure to access any one of those transceivers.

According to embodiments of the present invention, the transceiver 102 can identify some or all of the transceivers within its range by a different process.

Referring to FIG. 5b there is illustrated the same arrangement 100 illustrated in FIG. 5a. The Figure additionally illustrates the range of transceiver 108 by circle 130. The transceivers 102, 106, 108, 110 and 112 lie within the range 130, whereas transceiver 104 is outside the range 130. The transceiver 108 is adapted to store the Bluetooth Device address and the native clock value for one or more units other than itself. Henceforth the combination of a Bluetooth Device Address and native clock value for a transceiver will be referred to as an “Inquiry Pair” of the transceiver. Referring to FIG. 4, the memory 56 may be used to store Inquiry Pairs. The Bluetooth Device Address is a 48 bit address comprising three separate fields of respectively 24, 8 and 16 bits. The native clock value is a 26 bit number having a resolution of 1.25 ms.

As an example, in FIG. 5b, the transceiver 108 may store the Inquiry Pair for all or any of transceivers 102, 106, 110 and 112. These Inquiry Pairs may have been obtained by transceiver 108 previously carrying out an Inquiry Procedure or otherwise.

The transceiver 102 could identify some or all of the transceivers within its range 120 by obtaining from the transceiver 108, the Inquiry Pairs it is storing in its memory. Preferably the transceiver 102 would act as master and transceiver 108 would act as slave, with the master sending a request message which requests the slave to send its stored Inquiry Pairs. Consequently, the transceiver 102 is able to obtain the Inquiry Pairs for some or all of the transceivers within its range 120 without performing the Inquiry Procedure.

The transceiver 102 is also adapted to store Inquiry Pairs for one or more units other than itself. The transceiver 102 may store the Inquiry Pairs it has received from transceiver 108 and may transmit these Inquiry Pairs to another transceiver, at a later time, from which it has received a request message.

Embodiments of the present invention are particularly useful if a Bluetooth Device wishes to use a particular apparatus e.g. a printer or facsimile machine. It can according to embodiments of the invention, not only quickly determine if there is the possibility of one being within range but acquire the Inquiry Pair necessary to Page it while avoiding the time intensive Inquiry Procedure.

The transceiver 102 should be able to communicate with the transceivers 104, 106, 108 and 110 within its range 120 and form a network 2. The transceiver 102 operates as master 4 (FIG. 1) and the transceivers 104, 106, 108 and 110 are slaves. One, some or all of the transceivers 102, 104, 106, 108, 110, 112 are mobile. As time passes the position of the transceivers 102, 104, 106, 108, 110 and 112 may change. As this happens the network 2 varies and the identity of the transceivers within range 120 varies. Other ad-hoc networks may be formed by other transceivers acting as master.

Although the present invention has been described in the preceding paragraphs with reference to various examples, it should be appreciated that modifications and variations to the examples given can be made without departing from the scope of the invention as claimed.

1. A low power radio frequency transceiver capable of participating as a slave in an ad-hoc radio network including one or more other low power radio frequency transceivers, comprising:
storage means arranged to store data indicative of both the address and clock time of each of one or more other lower power radio frequency transceivers; and
a transmitter for transmitting the stored data indicative of both the address and clock time of one or more other low power radio frequency transceivers.

2. A low power radio frequency transceiver as claimed in claim 1, wherein the transmitter is arranged to transmit data indicative of both the address and clock time of multiple other low power radio frequency transceivers.

3. A low power radio frequency transceiver as claimed in claim 1 or 2, wherein the address of a low power radio frequency transceiver is dependent upon the Bluetooth Device Address (BD_ADDR) of the low power radio frequency transceiver.

4. A low power radio frequency transceiver as claimed in claim 1, 2 or 3, wherein the clock time is a 26 bit number.

5. A low power radio frequency transceiver as claimed in any preceding claim, further comprising:
a receiver for receiving a request message from a first low power radio frequency transceiver; and
means for controlling the transmitter to send a response message comprising data indicative of both the address and the clock time of one or more other low power radio frequency transceivers to the first low power radio frequency transceiver responsive to the received request message.

6. A low power radio frequency transceiver operable as a master of an ad-hoc network, comprising:
means for receiving from a first low power radio frequency transceiver, participating as a slave in the ad-hoc network, a message comprising data indicative of the address and clock time of at least a second low power radio frequency transceiver, different from the first low power radio frequency transceiver, and means for using said data indicative of the address and clock time to page the second low power radio frequency transceiver.

7. A low power radio frequency transceiver, as claimed in claim 6, wherein the means for receiving are arranged to receive from the first low power radio frequency transceiver, a message comprising data indicative of the address and clock time of multiple second low power radio frequency transceivers, different from the first low power radio frequency transceiver and wherein the means for using said data, is arranged to use said data indicative of the address and clock time of the multiple second low power radio frequency transceivers to page multiple second low power radio frequency transceivers.

8. A low power radio frequency transceiver as claimed in claim 6 or 7, wherein the address of a low power radio frequency transceiver is dependent upon the Bluetooth Device Address (BD_ADDR) of the low power radio frequency transceiver.

9. A low power radio frequency transceiver as claimed in claim 6, 7 or 8, wherein the clock time is a 26 bit number.

10. A low power radio frequency transceiver as claimed in claim 6, 7, 8 or 9 further comprising a transmitter for sending a request message to the first low power radio frequency transceiver wherein the response to the request message by the first low power radio frequency transceiver is the message comprising data indicative of the address and clock time of at least a second low power radio frequency transceiver.

11. A low power radio frequency transceiver as claimed in any one of claims 6 to 10 operable as a slave in an ad hoc network further comprising:
a memory for storing data indicative of both the address and clock time of each of one or more other lower power radio frequency transceivers; and
a transmitter for transmitting the data to a low power radio frequency transceiver operating as master of the ad-hoc network.

12. A method of identifying candidate transceivers for communication to a first low power radio frequency transceiver operating as a master of an ad-hoc network comprising the steps of:
storing in a second low power radio frequency transceiver, operating as a slave of the ad-hoc network data indicative of both the address and clock time of each of one or more other lower power radio frequency transceivers including a third low power radio frequency transceiver; and
transferring the data from the second low power radio frequency transceiver to the first low power radio frequency transceiver.

13. A method as claimed in claim 12 wherein the first, second and third transceivers are mobile.

14. A computer program product for providing in a first low power radio frequency transceiver, operable as a slave in an ad-hoc network means for storing in a memory data indicative of both the address and clock time of each of one or more other lower power radio frequency transceivers, including a second low power radio frequency transceiver, and for transmitting the data to a third low power radio frequency transceiver operating as a master of the ad-hoc network.

15. A computer program product for providing in a low power radio frequency transceiver, operating as master of an ad-hoc network, means for processing a received message including data indicative of the address and clock time of each of a plurality low power radio frequency transceivers and for paging at least one of the plurality of low power radio frequency transceivers using the data.
